(19) United States
(12) Patent Application Publication
(10) Pub. No.: US 2014/0339315 A1
(43) Pub. Date: Nov. 20, 2014

(54) Programmable Electronic Card and Supporting Device

(71) Applicant: TNT PARTNERS, LLC, Monroe Township, NJ (US)

(72) Inventor: Thomas Ko, Monroe Township, NJ (US)

(73) Assignee: TNT PARTNERS, LLC, Monroe Township, NJ (US)

(21) Appl. No.: 14/290,324

(22) Filed: May 29, 2014

Related U.S. Application Data
(63) Continuation-in-part of application No. 14/243,099, filed on Apr. 2, 2014.
(60) Provisional application No. 61/807,720, filed on Apr. 2, 2013.

(51) Int. Cl. G06K 19/06; H02J 7/00; G06F 1/16

(52) U.S. Cl. CPC G06K 19/06206; G06F 1/1628; H02J 7/0044
USPC 235/492

(57) ABSTRACT

A programmable electronic card assembly is provided. The programmable electronic card assembly comprising a smart phone having a receptacle, and a programmable electronic card positionable within and removable from the receptacle of the smart phone for providing power and communications interfaces with the electronic card, the card including a card body and a reprogrammable magnetic stripe positioned on a surface of the card body.

### CROSS-REFERENCE TO RELATED APPLICATION

This application is a continuation-in-part of U.S. patent application Ser. No. 14/243,099 filed Apr. 2, 2014, which claims priority to U.S. Provisional Patent Application No. 61/807,720 filed on Apr. 2, 2013, the disclosures of which are incorporated herein in their entirety by reference and made a part hereof.

### BACKGROUND OF THE INVENTION

1. Field Of The Invention

The present invention relates to a programmable electronic card and supporting device.

2. Related Art

Credit cards are conventionally made of plastic, usually flexible, in the format of ISO/IEC 7810 ID-1 and contain a magnetic stripe (e.g., magstripe). Such cards can also include an EMV (Europay, MasterCard and Visa) chip and an NFC (Near Field Communication) chip with unique account information. These components contain a unique number for a stored value account or an individual identification number. This particular card format has expanded in use to include prepaid cards, departmental cards, mileage cards, debit cards, transit cards, and even ID cards. They all operate under the same basic principle of passing a unique account information at the point of sale (POS) or point of identification, and to transfer specific additional information such as a specific currency value for physical payment. They typically utilize transfer mechanisms, such as a magnetic stripe, EMV chip or NFC chip. A POS device then reads account information data (e.g., values) and sends this data for a credit card transaction over a credit card network via Visa, Mastercard, American Express, etc. The credit card networks then perform the function of payment.

Credit card usage has grown during the last decades, especially in developed countries. It is common for an individual to carry more than one type of credit card and many different varieties of cards. During the last 4-5 years, mobile wallets came into being. The mobile wallets eliminate the inconvenience of carrying multiple cards by converting multiple cards into one mobile wallet application on a smart phone. Currently, the mobile wallet is primarily designed to work on NFC technology as the phone itself is not able to carry the credit card specific communication methods of a magnetic stripe or an EMV chip. However, POS readers are not formatted to handle ‘swiping’ of the smart phones due to the thickness of the phones. Therefore, smart phones and readers can be equipped with a new payment communication protocol using an NFC chip.

A smart phone has many electronic components that provide various functionality (e.g., camera, Internet access, video gaming, video chat, etc.). There have been many attempts to make a smart phone function as a mobile wallet using a software application with a communication protocol (e.g., NFC). However, at this time, NFC is not popular in most phones and POS terminals. This may be at least partly because such technology would require existing POS terminals to change to accept NFC communication protocol. The cost to add NFC technology is not trivial either. Moreover, NFC requires a user to use ‘tap’ action rather than ‘swipe’ action, which is very different, although arguably equally convenient, making it hard to force consumers to change their behavior from ‘swiping.’ A mobile wallet application on a phone also takes time-consuming actions to make a purchase, such as the following high-level examples: unlocking the phone, selecting an application, and then selecting a payment method. The combination of all of these factors has made the commercialization of smart phone-based mobile wallets very challenging.

### SUMMARY

A programmable electronic card is disclosed having, among other things, a dynamic reprogrammable magnetic stripe, dynamic programmable EMV chip, programmable NFC chip, Bluetooth technology, programmable RF chip, wireless transmitter, GPS, ultra-thin battery, and flexible displays (e.g., OLED screen, eInk screen, etc.). The electronic card is configured to provide credit card, electronic wallet, digital identification functionalities, among many other functionalities. The components of the electronic card are configured to fit within the size of a ISO/IEC 7810 ID-1 plastic card and function as a smart electronic device. A display screen (e.g., graphical user interface screen) allows a user to select one of the plurality of card accounts for use and displays a graphical emulation of a physical card on the user interface screen corresponding to the selected card account. Selecting a card account electronically reprograms the magnetic stripe, and/or EMV, and/or NFC chip to include information relating to the selected credit card for subsequent use of the card at a point of sale.

Further, the electronic card includes several applications for a variety of functions. A card chooser application recommends which card a user should use based on the location of the user and a comparison of the benefits (e.g., discounts, promotions, savings, points, etc.) available via different card programs of the user. Another application provides a user with his or her total credit exposure across all credit cards, prepaid cards, membership cards, etc. Another application provides a digital storage mechanism for digitally saving offers and coupons. Further applications could provide a user with the ability to obtain, respectively, a gift card, membership card, credit card, or transit card. Another application allows a user to obtain and use a digital passport stored on the electronic card.

### BRIEF DESCRIPTION OF THE DRAWINGS

The foregoing features will be apparent from the following Detailed Description, taken in connection with the accompanying drawings, in which:

FIG. 1 is a front view of an electronic credit card;

FIG. 2 is a back view thereof;

FIG. 3 is a diagram of the internal components thereof;

FIG. 4 is a diagram of the electronic card in a cloud environment;

FIG. 5a is a view showing examples of card displays provided on the electronic card;

FIG. 5b is a view showing swiping movements for scrolling through the card displays of FIG. 5a;

FIG. 6 is a view of a main page display of the electronic card;

FIG. 7 is a flow diagram of the process of card selection/de-selection;

FIG. 8 is a view of the electronic card showing identification information;

FIG. 9 is a diagram showing electronic credit card software applications installed on the electronic credit card;

FIG. 10 is a flowchart showing processing steps carried out by a card chooser application;

FIG. 11 is a flowchart showing processing steps carried out by an account summary application;

FIG. 12 is a flowchart showing processing steps carried out by a coupon application;

FIG. 13 is a flowchart showing processing steps carried out by a gift card application;

FIG. 14 is a flowchart showing processing steps carried out by a membership card application;

FIG. 15 is a flowchart showing processing steps carried out by a credit card application;

FIG. 16 is a flowchart showing processing steps carried out by a transit card application;

FIG. 17 is a flowchart showing processing steps carried out by a digital passport application;

FIG. 18 is a diagram showing a series of display screens of the electronic card;

FIG. 19 is a perspective view of a programmable electronic card assembly with a programmable electronic card removed from its associated electronic card holster;

FIG. 20 is a bottom perspective view of the electronic card assembly of FIG. 19 with the electronic card retained within the electronic card holster;

FIG. 21 is a top perspective view of the electronic card assembly of FIG. 19 with the electronic card retained within the electronic card holster;

FIG. 22 is a rear perspective view of the electronic card assembly of FIG. 19 with the electronic card partially removed from the electronic card holster;

FIG. 23 is a bottom perspective view of a programmable electronic card assembly with a programmable electronic card and a smart phone; and

FIG. 24 is a bottom perspective view of the electronic card assembly of FIG. 23 with the electronic card received within the smart phone.

### DETAILED DESCRIPTION

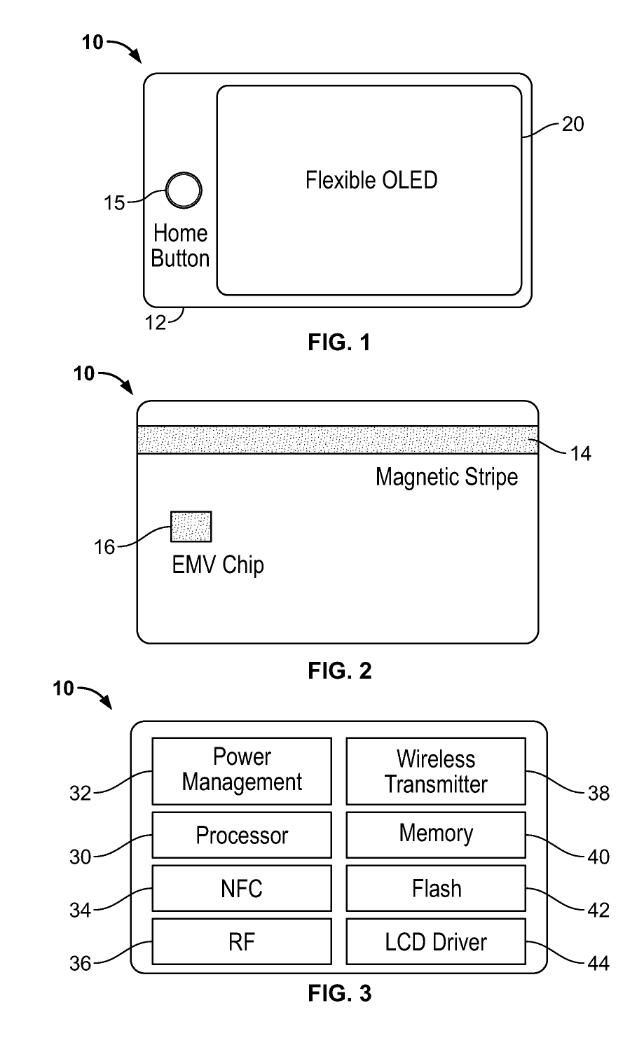

A programmable electronic card (e.g., electronic credit card), as discussed herein, functions as a smart electronic wallet on a credit card sized device having a display screen (e.g., electronic ink (eInk) screen, flexible organic light emitting diode (OLED) screen, etc.) providing touch-friendly behaviors, text inputs via virtual keyboards, scrolls, etc. The electronic card is battery powered. The basic components of the electronic card (e.g., front, back, internal, etc.) are described below with reference to FIGS. 1-18.

FIG. 1 shows a front view of the electronic card, generally indicated at 10, comprising a body 12, a home button 15 (which could include fingerprint scanning functionality), and a display 20. The display 20 comprises a graphical user interface screen positioned in a front surface of the card body. The display 20 could be an OLED display, or other display, and could be flexible or bendable. The display 20 could include a touch screen, which could have a heat-sensor, or other position sensor. The electronic card operating system (OS) could be based on a smart phone OS (or any OS customized for this device), and all regular basic features of a smart phone could be supported (e.g., regular high resolution display, virtual keyboard (support of multi-languages), swipe control, back button, home button, menu button, etc.).

The electronic card 10 can be locked by default. The user can have the option to select different methods for personalized unlocking similar to a smart phone interface. The electronic card can automatically turn on or off based on light sensed by the card. When the card is in a wallet (no light), it can automatically turn off. On the other hand, when the card is taken out of a wallet (light), it can automatically turn on. Also, the home button 15 can be used to manually turn the card on or off. The home button 15 could include a fingerprint scan so that when the home button 15 is used to turn on the card, the fingerprint scan can authenticate and identify the authorized user through the home button 15.

FIG. 2 shows a back view of electronic card 10, including a magnetic stripe 14 and an EMV chip 16. The magnetic stripe can be on a back surface of the card body and can be reprogrammable depending on the card account a user selects and/or the card account a user sets as a default account.

FIG. 3 shows internal components of the electronic card 10, including a processor 30, power management 32, near field communication (NFC) chip 34, radio frequency (RF) chip 36, wireless transmitter 38, memory 40, flash memory 42 and LCD driver 44. The processor 30 is positioned within the card body and is in electrical communication with the reprogrammable magnetic stripe and the graphical user interface screen. The memory 40 is positioned within the card body and is in communication with the processor. The memory 40 stores information relating to a plurality of card accounts owned by the user.

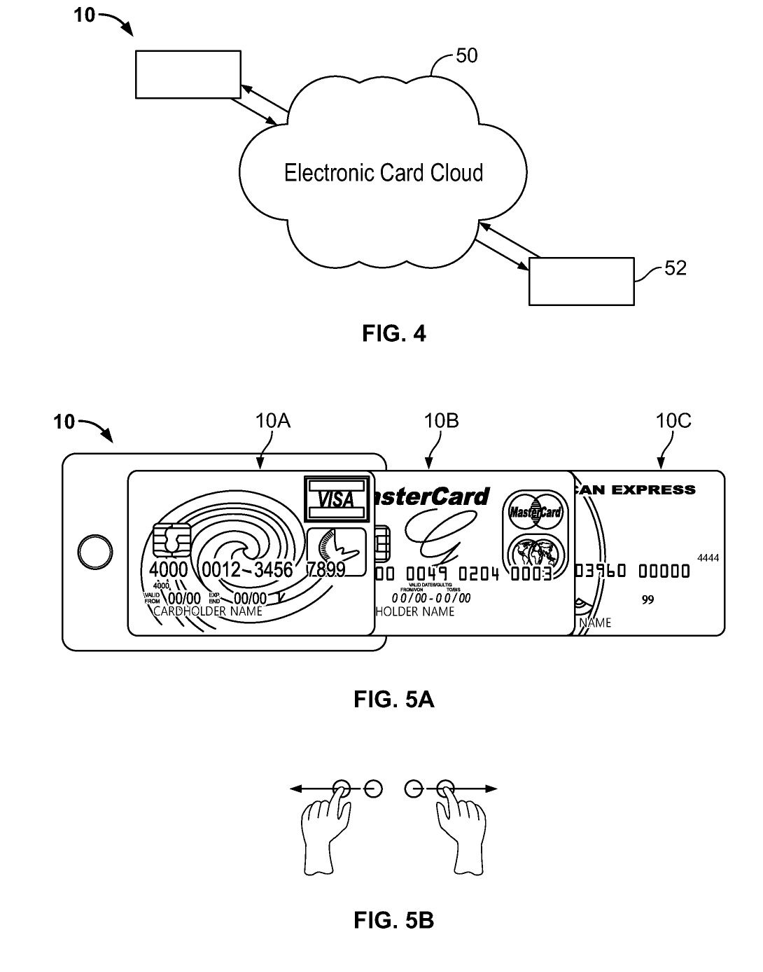

FIG. 4 shows electronic card 10 in communication with computer system 52 over a cloud computing system 50. The computer system 52 can be any computer system or server of a card issuing entity or third party entity, such as a credit provider, credit claiming entity, or website. Communication can take place over any known communication network (e.g., a cloud). The cloud can contain all of the information of a user who registers a programmable electronic card. Therefore, if a card is lost, a new electronic card can be provided with the same information from the cloud. The electronic card can use an Internet connection to send and receive data and information with the electronic card server and other Internet websites.

Some of the major similarities and differences between features that may be incorporated into the electronic card, discussed herein, a conventional credit card, and a smart phone based mobile wallet are shown in Table 1.

TABLE 1

| | | Regular Credit | |
|---|---|---|---|
| | Electronic Card | Card | Mobile Wallet |
| Size | ISO/IEC | ISO/IEC | Varies based |
| | 7810 ID-1 | 7810 ID-1 | on Phone |
| Magnetic Stripe | Yes (Dynamic) | Yes (Static) | No |
| EMV Chip | Yes (Dynamic) | Yes (Static) | No |
| NFC Chip | Yes (Dynamic) | Yes (Static) | Yes (Dynamic) |
| RF Chip (FeliCa) | Yes (Dynamic) | No | No |
| Printed personal | Yes | Yes | No |
| picture | | | |
| Printed signature | Yes | Yes | No |
| Customizable card | Yes | Yes with | Yes |
| design | | high cost | |
| Bendable | Yes | Yes | No |
| Fit in the wallet | Yes | Yes | No |
| Function without | Yes | Yes | No |
| Power | | | |
| Function without | Yes | Yes | No |
| Internet Connection | | | |
| Internet connection | Yes | No | Yes |
| Digital Display | Yes | No | Yes |
| screen | | | |
| Smart phone OS | Yes | No | Yes |
| Powered | Yes | No | Yes |
| Application Store | Yes | No | Yes |
| Requires New POS | No | No | Yes |
| Embossing of account | No | Yes | No |
| number | | | |

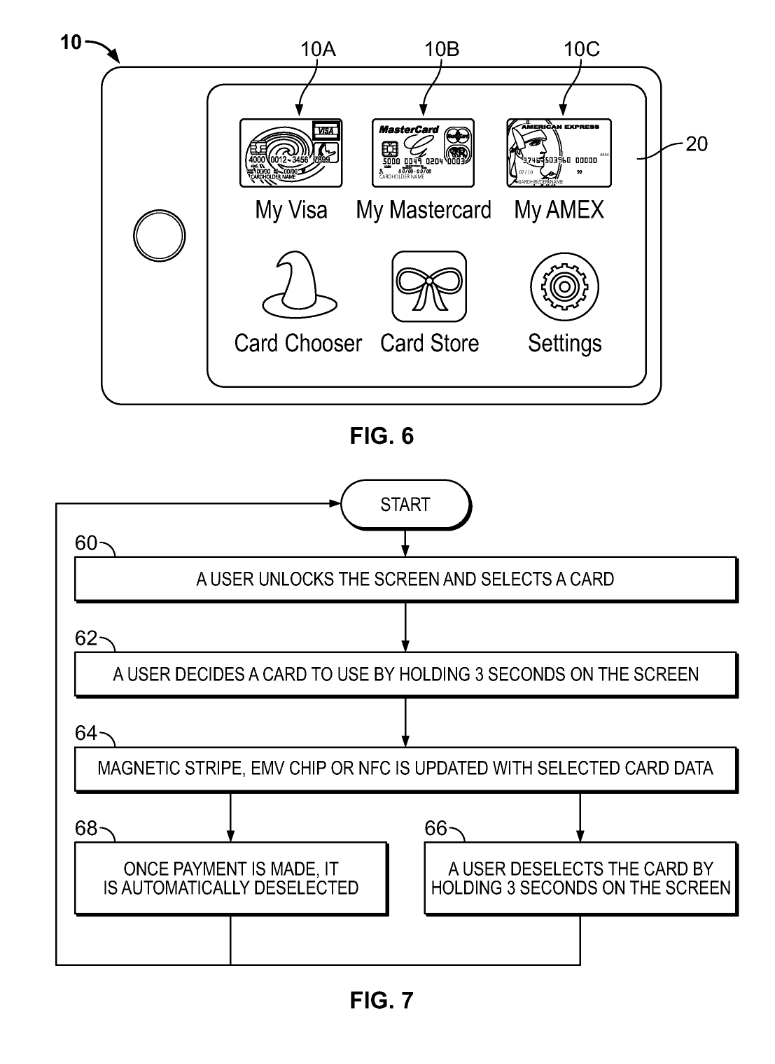

Multiple credit cards (e.g., accounts) and/or different varieties of cards can be registered via a cloud computing system, directly using the electronic card smart interface by entering account and personal information, or otherwise. The personal information captured via the electronic card may be verified with a credit card company, and then the registration may be finalized. When the electronic card is registered through the electronic card directly, the electronic card can send information over cloud 50 to computer system 52 to verify and register a card. Once registration is complete, the physical front cover of the card 10A can be downloaded to electronic card, which can then digitally display the card. In this way, the graphical user interface screen visually emulates the physical appearance of the card (e.g., credit card, membership card, etc.). As shown in FIGS. 5a and 5b, additional cards that are registered 10B, 10C can be displayed via finger swiping (e.g., left to right, or right to left, etc.). Those additional cards can also be displayed as individual icons on the main page of electronic card display 20, as shown in FIG. 6. The order of the cards can be changed anytime by changing the order in the home screen.

Referring to FIG. 7, a user first unlocks the electronic card as per step 60. To select a specific card for payment, a user can press an image on the display and hold (for 3 seconds, for example) as per step 62. As per step 64, the electronic card then locks and sends the card information to payment instruments (e.g., a magnetic stripe 14, EMV chip 16 and/or a NFC chip 34). The card selection lock can be released by pressing on the screen and holding (for 3 seconds, for example) 66. The card can also be automatically released 68 from the payment instruments once a payment is made.

The electronic card can have a default card that is always the first card to appear on the screen when the electronic card is turned on and it can be automatically configured with the payment instruments as a default. A user can deselect the default card to select any other card for the method of payment and also change the default card at anytime. In a variation, the electronic card has a default card that cannot be changed by a user. The electronic card can be configured such that when the battery is drained, and the display cannot be turned on, the electronic card can still function as a normal credit card with the default card information being used to make purchases.

Using an RF chip, such as an RFID smart card system in compliance with an open communication protocol (e.g., the FeliCa standard made by Sony), the electronic card can also function as a transit card where RF technology is used in public transportation systems. To store value, a unique identification of the electronic card can be registered with the transportation system. A user can prepay a certain value to an account linked to the electronic card. Merchant-specific gift cards that work similarly to transit cards in that they utilize a unique account number with an associated prepaid value, can also be incorporated into the electronic card. The electronic card can store a plurality of merchant gift cards having a unique stored value account for each merchant where the account can be virtually accessed (e.g., to increase the stored value).

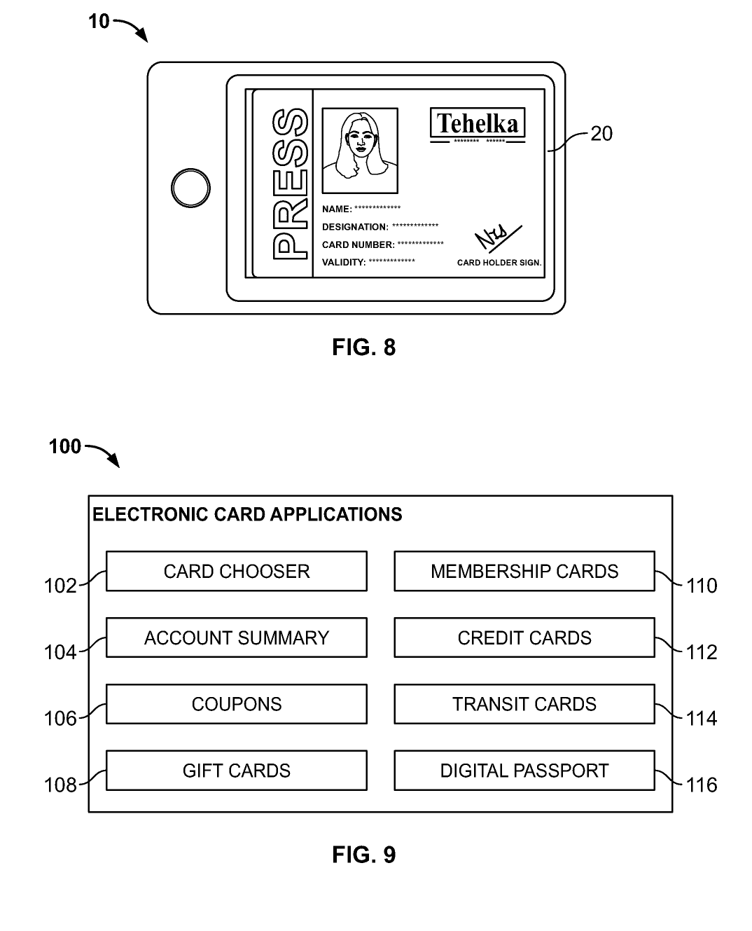

Using an RF chip (e.g., Sony FeliCa) or EMV chip, the electronic card can also function as individual identification where the electronic card's unique number is registered with a database of an identification management system so that the system can recognize the unique identification of the electronic card. Further, an ID picture and associated information can be shown via the flexible OLED screen as shown in FIG. 8. A personal picture with a hand-written signature can also be engraved on the back of the card for identification purposes.

FIG. 9 is a diagram showing electronic credit card software applications 100 installed on the electronic credit card. A programmable electronic card application “store” can be a default icon for the electronic card that opens up an application store specifically developed and available for electronic card users to download and install applications. Some examples of the card applications include a card chooser application 102, an account summary application 104, a coupon application 106, a gift card application 108, a membership card application 110, a credit card application 112, a transit card application 114, and a digital passport application 116.

1. Card Chooser Application

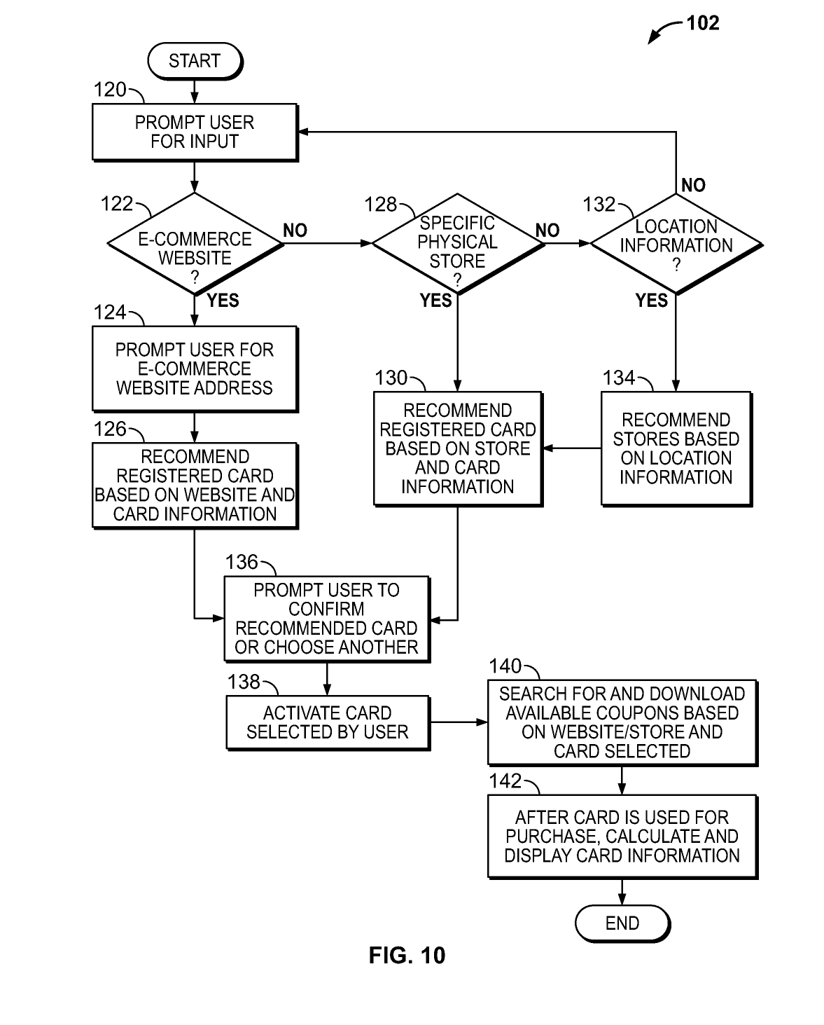

FIG. 10 is a flowchart showing processing steps carried out by the card chooser application 102. A user with multiple credit cards having different offerings might not be totally familiar with which card provides the most benefit at the location of purchase. The electronic card chooser can make an intelligent recommendation as to which card to use based on the location of a user and a comparison of the discount/promotion/savings available via different card programs of a user. This application could require a user to agree to allow the card chooser application to use a user's electronic card data and other information.

As a preliminary step, a user can register cards (e.g., credit cards, membership cards, debit cards, mileage cards, gift cards, etc.) with the electronic credit card and agree to any required “Terms and Conditions” so that individual account information of a user can be pulled from credit card companies. In step 120, after the application launches, the application prompts the user for input, such as whether a user is looking for a recommendation regarding an e-commerce website or a store at a physical location. In step 122, a determination is made (based on the user input) as to whether a user is inquiring about an e-commerce website. If so, the process proceeds to step 124, where the application prompts a user for the website address. In step 126, based on the website information and card information (e.g., credit card points, mileages, coupons, etc.), the application recommends a registered card (e.g., credit card and/or membership card).

If, in step 122, a negative determination is made, the process proceeds to step 128, and a determination is made as to whether a user is inquiring about a specific physical store. If so, the process proceeds to step 130 and the application recommends a registered card (e.g., credit card and/or membership card) for a user based on store information and card information (e.g., credit card points, mileages, coupons, etc.).

If a negative determination is made in step 128, then the process proceeds to step 132, and a determination is made as to whether a user is inquiring about a physical location. If not, the process reverts to step 120. Otherwise the process proceeds to step 134, and the application recommends stores in the area based on location information (e.g., using GPS) and card information, and then proceeds to step 130 after a user selects a desired store in the area.

Both steps 126 and 130 then proceed to step 136 where the application prompts a user to confirm the recommended card or to choose another card. In step 138, the card selected by a user is activated. In step 140, the system could search for any available coupons (stored within the device or available over the Internet) and provide the coupons to a user (based on a store or location). In step 142, after the card has been used to purchase a product or service, the credit card information (e.g., current balance, points accumulated by purchase, total points accumulated, etc.) is calculated and displayed to a user.

2. Account Summary Application

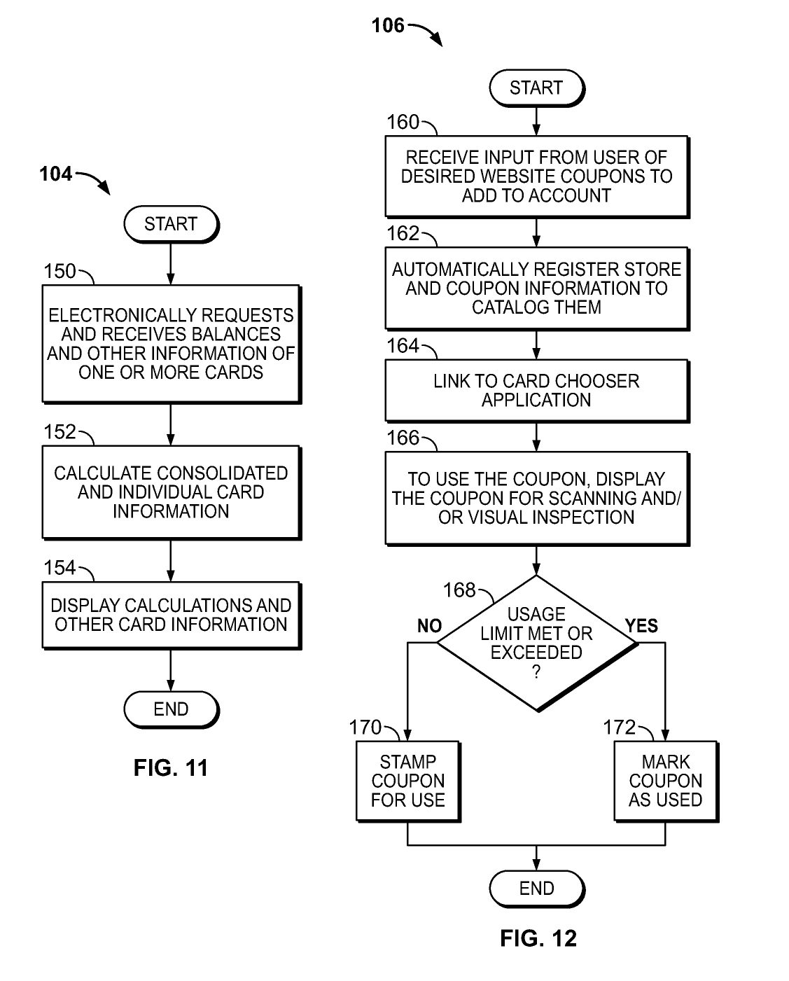

FIG. 11 is a flowchart showing processing steps carried out by an account summary application 104. This application offers a user the total credit exposure a user has with all credit cards, prepaid cards, departmental cards and membership cards by accumulating all current balances against a total line of credit, and also all virtual points accumulated in different merchants or membership programs.

As a preliminary step, a user can register all of his or her cards (e.g., credit cards) with the electronic credit card and agree to any required “Terms and Conditions” so that individual card information of the user can be pulled from card companies (e.g., credit card companies). In step 150, after the application launches, the application electronically requests and receives balances and other information of one or more cards from one or more card companies. In step 152, the application calculates consolidated and individual card information. Then in step 154, the application displays the calculations and other card information (e.g., total balance, total available credit, total debt, total purchasing power, total points, future expiration, sum of all balances outstanding and earliest date for payment). Card information could include credit card information (e.g., sum of all credit lines, sum of all credits unused, sum of different points per card, sum of different “cash back” rewards per card, etc.), prepaid/gift card information (e.g., sum of all prepaid/gift card original values, sum of all spending, sum of all remaining values, etc.), mileage or membership cards (e.g., sum of all mileages or points, indicative cash values of those mileages or points if converted to one or more gift items, expiration dates).

3. Coupon Application

FIG. 12 is a flowchart showing processing steps carried out by a coupon application 106. The application provides a digital storage mechanism for saving offers and coupons from various sources such as Facebook, Groupon, Foursquare, RetailMeNot, etc. The application “clips” web coupons, saves them and indexes them to be searched later. This application could be used independently or in combination with other applications such as the card chooser application.

In step 160, the application receives input from a user about one or more desired website coupons to add to the account. Alternatively, or additionally, the application could recommend coupons for a user to add to the account (e.g., based on Internet use, shopping history, etc.). In step 162, based on the input received, the application automatically registers store and coupon information and catalogs such information. Optionally, in step 164, the coupons could be linked to the card chooser application. In step 166, to use a coupon, the coupon is displayed for scanning and/or visual inspection. Alternatively, if the purchase is being done through the device over the Internet, the coupon could be automatically added to the purchase. In step 168, a determination is made as to whether the usage limit of the coupon has been met or exceeded. If not, in step 170, the coupon is digitally stamped (either for the user's own records, or if there is a usage limit on the coupon). Otherwise, in step 172, the coupon is marked as “used.”

4. Design Application

The My Design application offers a specific application to allow a user to design the look and feel of the credit card digital interfaces permitted by credit card companies.

5. Gift Card Application

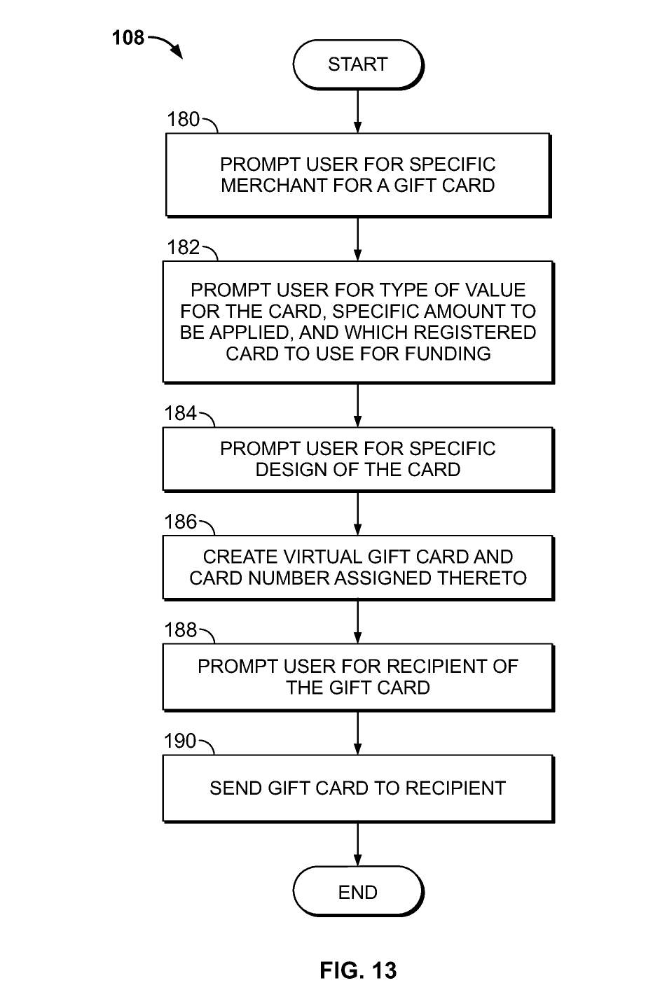

FIG. 13 is a flowchart showing processing steps carried out by the gift card application 108. A digital gift card store can be provided for a programmable electronic card user to send a gift card as a gift to another electronic card user by entering the recipient's contact information. In step 180, the application prompts a user for a specific merchant for the gift card. In step 182, the application prompts a user for the type of value for the card, the specific amount to be applied, and which registered card (e.g., credit card) to use for funding. In step 184, the application could optionally prompt a user for a specific design for the card. This allows a user to customize the appearance of the card. In step 186, the application creates the virtual gift card and a card number is assigned thereto. In step 188, the application prompts a user for the recipient of the gift card and, once received, in step 190 the application sends the gift card to the recipient.

6. Membership Card Application

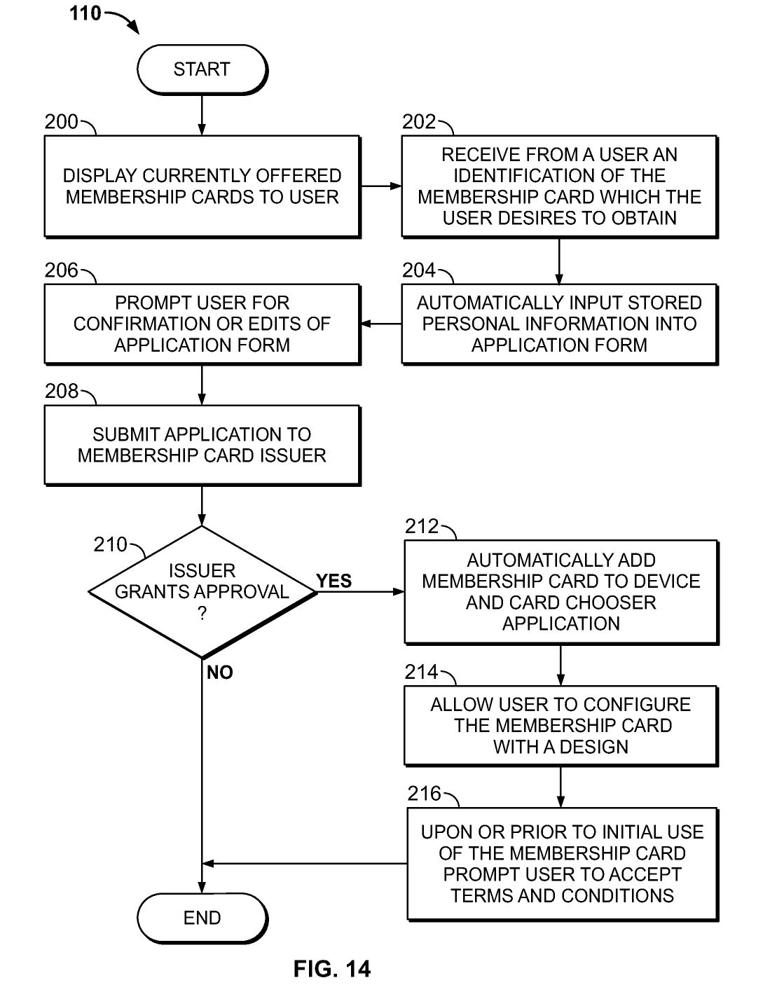

FIG. 14 is a flowchart showing processing steps carried out by a membership card application 110. Any membership card can be installed on the electronic card. In step 200, the application displays the currently offered membership cards to a user (where such cards could be searchable). In step 202, the application receives from a user an identification of the membership card which a user desires to obtain. In step 204, the application automatically inputs stored personal information of a user into an application form for the membership card. In step 206, the application prompts a user for confirmation or edits of the form. Once confirmed and/or revised, in step 208, the application electronically submits the form to a membership card issuer.

In step 210, a determination is made as to whether the issuer grants approval. If not, the process ends. Otherwise, the process proceeds to step 212, and the application automatically adds the membership card to the device and (optionally) to the card chooser application 102 (See FIG. 9). In step 214, the application could (optionally) allow a user to configure (customize) the membership card with a design. In step 216, upon or prior to the initial use of the membership card, the device could prompt a user to accept terms and conditions of the membership card.

7. Credit Card Application

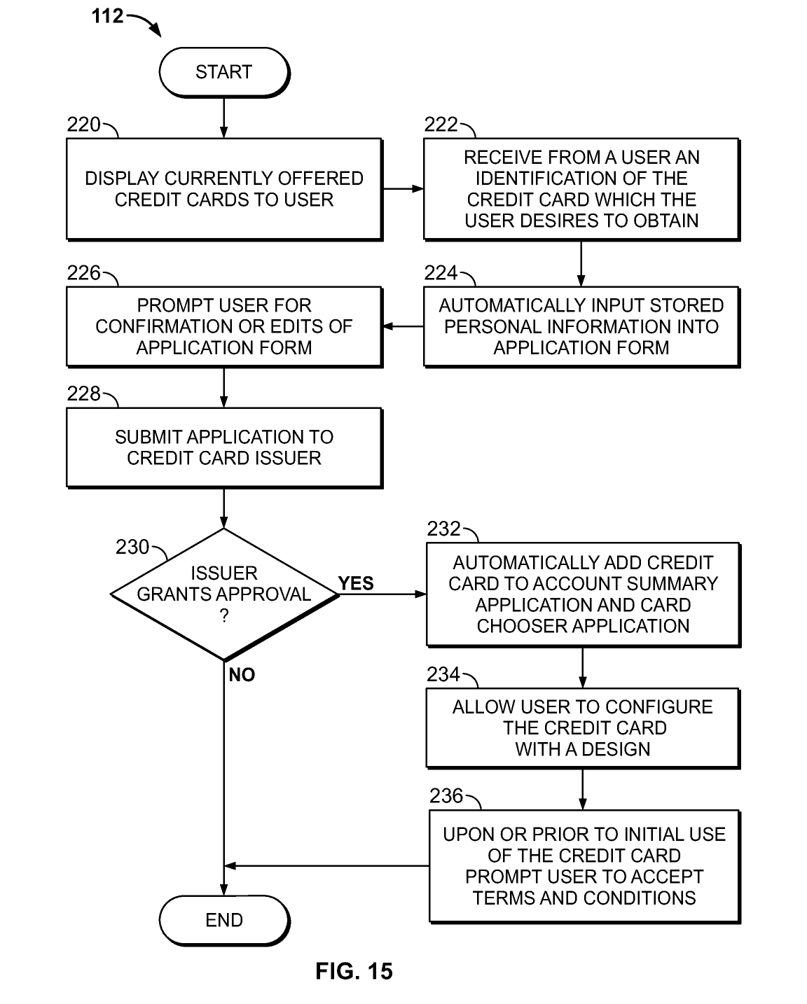

FIG. 15 is a flowchart showing processing steps carried out by the credit card application 112. Credit card companies can offer their credit cards through applications that can be obtained from the card store. In step 220, the application displays the currently offered credit cards to a user (where such cards could be searchable). Additionally, the application could be confirmed to only display those cards a user would most likely be granted. In step 222, the application receives from a user an identification of the credit card which a user desires to obtain. In step 224, the application automatically inputs stored personal information of a user into an application form for the credit card. In step 226, the application prompts a user for confirmation or edits of the form. Once confirmed and/or revised, in step 228, the application electronically submits the form to a credit card company.

In step 230, a determination is made as to whether the credit card company grants approval. If not the process ends. Otherwise the process proceeds to step 232, and the application automatically adds the credit card to the electronic card (e.g., account summary application) and (optionally) to the card chooser application 102 (See FIG. 9). In step 234, the application could (optionally) allow a user to configure (customize) the credit card with a design. In step 236, upon or prior to the initial use of the credit card, the device could prompt a user to accept terms and conditions of the credit card.

8. Transit Card Application

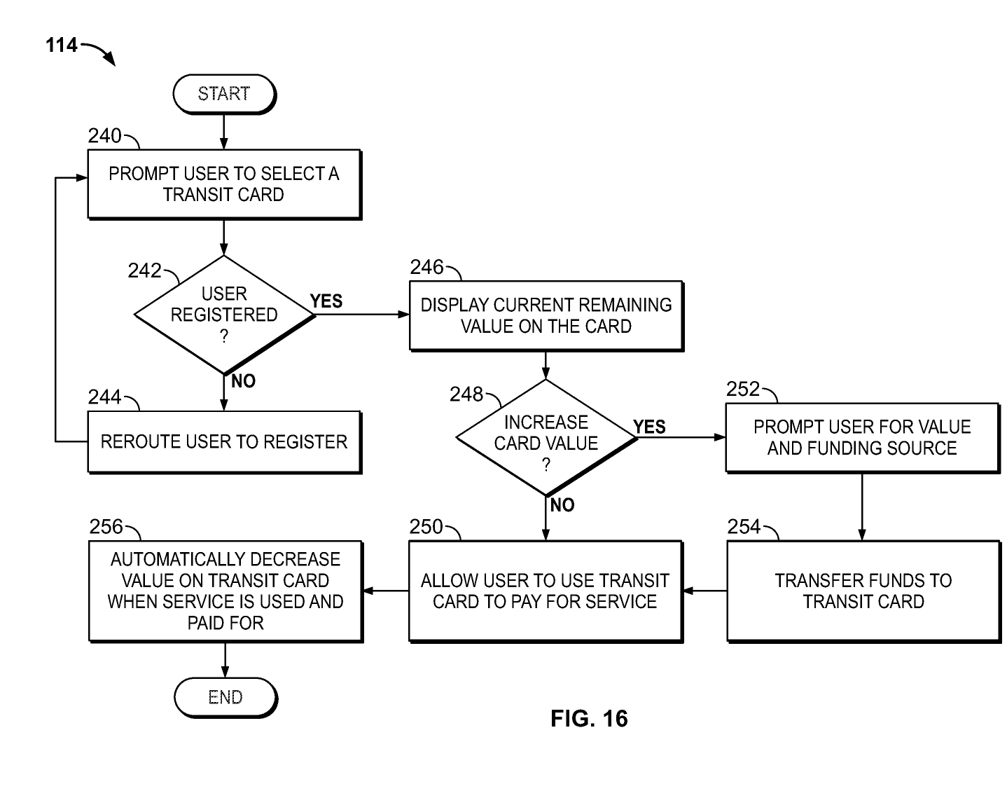

FIG. 16 is a flowchart showing processing steps carried out by the transit card application 114. Advantageously, the electronic card can be used to obtain and use transit cards for various transportation systems. In step 240, the application prompts a user to select a transit card. In step 242, the application makes a determination as to whether a user is registered for the transit card selected (although alternatively, the application could display the transit cards for which a user is already registered). If a user is not registered, in step 244, the user is rerouted to a website or other screen for registration, and then the process reverts back to step 240.

Otherwise, the process proceeds to step 246 and the application displays the current remaining value on the selected transit card. In step 248, the application determines (based on user input or automatically based on funds remaining) whether a user wants to increase the value on the transit card. If negative, the process proceeds to step 250, and the application allows the user to use the transit card to pay for a service. Otherwise, in step 252, the application prompts the user for a value and funding source (e.g., registered credit card), and then in step 254 funds are transferred to the transit card, and then the process proceeds to step 250. In step 256, the application automatically decreases the value on the transit card when the service is used and paid for.

9. New Card Store Application

The new card store application can be used to purchase different types of gift cards, membership cards, new credit cards, transit cards, etc.

10. Digital Passport Application

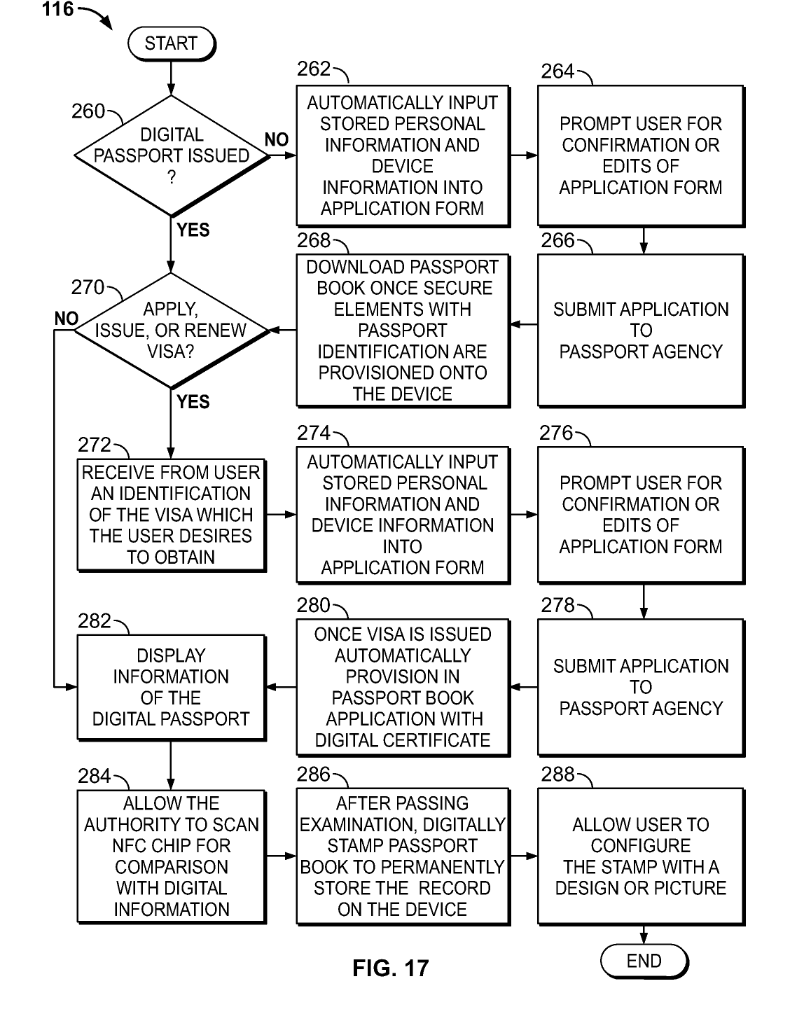

FIG. 17 is a flowchart showing processing steps carried out by the digital passport application 116. In step 260, the application makes a determination as to whether a digital passport has been issued for a user. If so, the process proceeds to step 270. Otherwise, in step 262, the application automatically inputs stored personal information and device information in an application form. In step 264, the application prompts a user for confirmation or edits to the form. In step 266, after the user confirms and/or revises the form, the form is submitted electronically to the passport agency. In step 268, after secure elements with passport identification are provisioned onto the device (e.g., by the passport agency), the passport book is downloaded. These steps can be repeated when the passport is at or near expiration.

In step 270, the application determines (based on user input) whether a user wants to apply, issue, or renew a visa. If not, the process proceeds to step 282. Otherwise, the process proceeds to step 272, and the application receives from a user an identification of the visa which a user desires to obtain. In step 274, the application automatically inputs stored personal information and device information in an application form. In step 276, the application prompts a user for confirmation or edits of the form. In step 278, after a user confirms and/or revises the form, the form is submitted to the passport agency. In step 280, once the visa is issued, it is automatically provisioned into the passport book application with a digital certificate. These steps can be repeated when the visa is at or near expiration.

In step 282, when a user needs to present the passport and related information to an authority (e.g., immigration office), the application displays information of the digital passport for inspection. In step 284, the application allows the authority to scan the NFC chip for comparison with the digital information on the device. In step 286, after passing examination by the authority (if appropriate), the passport is digitally stamped and stored in the record on the device. Optionally, in step 288, the application could allow a user to configure the stamp with a design and/or picture.

The electronic card can save transaction data locally and synchronizes (wirelessly) to the cloud, which is a backup of the electronic card data by default. A computer and/or smartphone could also be used as backup storage for the electronic card. In case the electronic card data malfunctions, it can be self-restored by using such a backup.

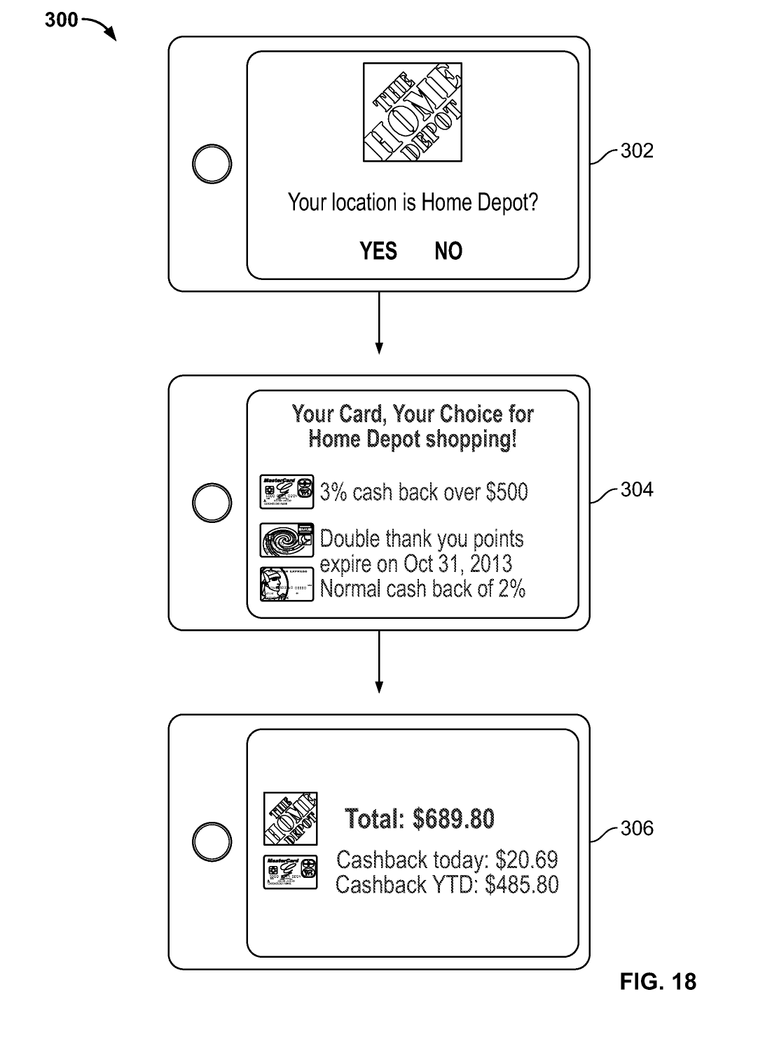

FIG. 18 is a diagram 300 showing a series of display screens of the electronic card. As described above, a user could input an address or location, and/or the electronic credit card could estimate an address or location (e.g., from GPS data). The electronic card could prompt the user for physical location confirmation using display screen 302, such as which store the user is located (e.g., “Your location is Home Depot?”). Once confirmed by the user, the electronic card could recommend one or more credit cards for the user to make a purchase using display screen 304 (e.g., recommending Card A due to “3% cash back over $500,” Card B due to “Double thank you points expire on Oct. 31, 2013,” and/or Card C due to “Normal cash back of 2%”). Once the desired credit card is selected by the user, the electronic card completes the transaction and displays a summary of the transaction to the user using display screen 306, such as by displaying the total purchase price (e.g., “Total $689.80”), the cash back amount (e.g., “Cash back today: $20.69”), and/or the cash back amount accumulated by the user to date (e.g., “Cash back YTD: $485.80).

It is contemplated that different variations of the electronic card can be offered, including, but not limited to:

A. Electronic Card Basic

This card is for an individual consumer. This card is flexible to select any default card and open to any card store. The information is all owned by the user and totally customizable by the user only. The security level is medium providing standard encryption and secure storage.

B. Electronic Card Corporate

This card is for a corporate issuer could be given to either its customers or employees. The card comes with a pre-defined default credit card and ID that cannot be changed by a user. The data cannot be changed or deleted by the user. Thus, the card is not transferrable. On the other hand, users can still input personal data to load additional card and IDs to use for personal purposes. This electronic card information can be co-owned by the user and the corporation and it can be semi-customizable by the user. The corporate issuer also has an ability to configure the electronic card wirelessly. The security level is high with custom security implementations of the corporate standard.

C. Electronic Card Maximum

This card is for special circumstances given to unique individuals for soldiers, government employees, or any other employees of a sensitive work place. The card comes with a pre-defined ID and corporate credit account that cannot be changed by a user. A user also cannot enter personal card and ID information. The card information is only owned by the card issuer and card issuer has an ability to configure or wipe out wirelessly. The security level is customizable per issuer. The following is a summary of some potential features of three potential different electronic cards:

| | Electronic Card | Electronic Card | Electronic Card |
|---|---|---|---|
| | Basic | Corporate | Maximum |
| Size | ISO/IEC | ISO/IEC | ISO/IEC |
| | 7810 ID-1 | 7810 ID-1 | 7810 ID-1 |
| Magnetic Stripe | Yes | Yes | No |
| (Dynamic) | | | |
| EMV Chip (Dynamic) | Yes | Yes | Yes (Static) |
| NFC Chip (Dynamic) | Yes | Yes | Yes (Static) |
| RF Chip | Yes | Yes | Yes (Static) |
| Printed Personal | Optional | Yes | Yes |
| Picture | | | |
| Printed signature | Yes | Yes | Yes |
| Customizable card | Yes | Yes | No |
| design | | | |
| Personal Card | Yes | Yes | No |
| loading | | | |
| Change default | Yes | No | No |
| card | | | |
| Change ID | Yes | No | No |
| Change Owner | Yes | No | No |
| Security | Medium | High | Maximum |
| OTA corporate | No | Yes | Yes |
| provisioning | | | |
| Ownership of | Individual | Individual/ | Issuer |
| Data | | Corporate | |
| Card App Store | Open | Customized by | Only by the |
| | | Corporate | Issuer |

Additional security measures that could be utilized could include, if the electronic card is lost, relaying such information to all companies registered with the user.

Other supporting devices could be considered to provide additional power (e.g., to connect a programmable electronic card to the Internet). For example, a holster could hold the programmable electronic card and perform one or more functions (e.g., Internet connectivity, card charging, additional display for control of the card and/or the cloud, etc.). Other types of supporting devices could also be used to augment the usability of the programmable electronic card.

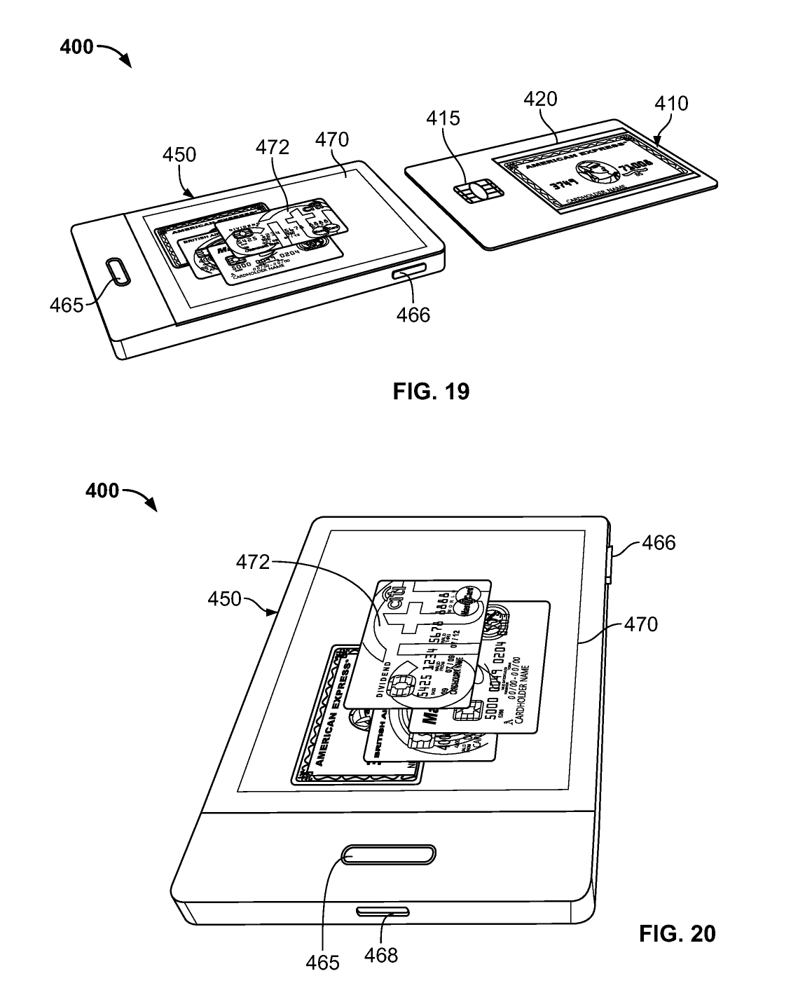

FIGS. 19-20 are views of a programmable electronic card assembly 400 comprising a programmable electronic card 410 and a programmable electronic card holster 450. More specifically, FIG. 19 is a perspective view of a programmable electronic card assembly 400 with a programmable electronic card 410 removed from its associated electronic card holster 450. The electronic card 410 can be configured like and operate like the electronic card of FIGS. 1-18. The electronic card 410 includes a home button 415 and display 420. The display 420 comprises a graphical user interface screen positioned in a surface of the card body, which can display one or more selected registered cards (e.g., credit cards) and/or other accounts. The display 420 and/or home button 415 could allow a user to choose among one or more registered cards and/or other accounts (among other functions).

The electronic card holster 450 comprises a card holster body that could include a home button 465, and display 470 (e.g., with a graphical user interface screen positioned in a front surface of the card holster 450). The electronic card holster 450 (and/or each of its components) could have some or all of the same functionality as the electronic card 420 (and/or each of its components), or it could share such functional aspects with the electronic card. For example, the card holster 450 could comprise a processor, a memory, etc., which function the same or similarly to the processor and memory of the electronic card 410. Additionally, the electronic card holster 450 could include a switch such as a side button 466 located on a side of the electronic card holster 450 to turn the display 470 on/off, eject the electronic card 410, and/or any other suitable function.

The display 470 and/or home button 465 of the electronic card holster 450 could allow a user to choose among one or more registered cards 472 (e.g., credit cards) and/or other accounts. Upon choosing a particular registered card or account on the electronic card holster 450, the electronic card holster 450 communicates with the electronic card 410 to activate the selected card or account on the electronic card 410. In this way, when the electronic card 410 is removed from the electronic card holster 450, the electronic card 410 is set up to the selected card or account and ready for use. However, the display 420 of the electronic card 410 could still be operational so that a user can choose a different card or account even after the electronic card 410 is removed from the electronic card holster 450.

Alternatively, the holster 450 and/or card 410 could not include a display screen. For example, in a scaled back version, the holster 450 could not include a display screen and merely provide power and/or connectivity (e.g., Internet connectivity) for the card 410, such as through a power interface and/or a communications interface.

FIG. 20 is a bottom perspective view of the electronic card assembly of FIG. 19 with the electronic card retained within the electronic card holster. The increased size of the electronic card holster 450 (e.g., 89 mm length, 58 mm width, and 6 mm thickness) compared to the electronic card 410 allows for a comparatively larger battery. As a result, the electronic card holster 450 could charge the electronic card 410 when holstered therein (e.g., induction charging), either when the holster 450 is connected or disconnected from a power source (e.g., via mini USB connection 468, or other connection, such as in the bottom of the electronic card holster 450). Thereby, the electronic card holster 450 could extend the battery life of the electronic card 410. Further, the electronic card holster 450 could include a communications interface to communicate (wired or wirelessly) such that it is Internet capable and can provide Internet connectivity (e.g., where such connectivity could depend on whether the electronic card 410 is holstered), so as to preserve the battery of the electronic card 410 (as Internet use can be particularly power intensive).

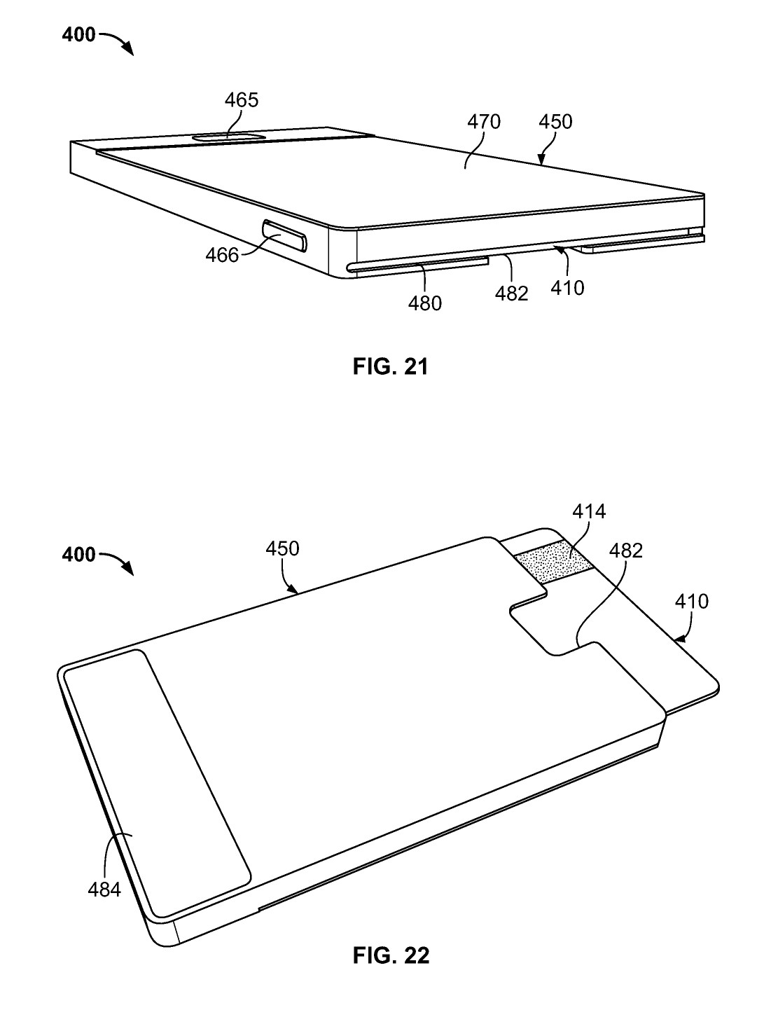

FIG. 21 is a top perspective view of the electronic card assembly of FIG. 19 with the electronic card 410 positioned in the electronic card holster 450 (e.g., within a receptacle of the electronic card holster 450). More specifically, the electronic card 410 is retained within slot 480 accessible from the top of the electronic card holster 450, although the slot 480 could alternatively be positioned in a side or bottom of the electronic card holster 450. The slot 480 is similarly sized to the dimensions of the electronic card 410 so as to provide a tight fit (e.g., to prevent the electronic card 410 from accidentally falling out). However, the slot 480 could be of any size or shape, and any retaining mechanism could be used (e.g., clips) in addition to or instead of the slot 480.

FIG. 22 is a rear perspective view of the electronic card assembly of FIG. 19 with the electronic card 410 partially removed from the electronic card holster 450. The back of the electronic card holster 450 could include a notch 482 proximate to slot 480, to facilitate user access to and removal of the electronic card 410 from the electronic card holster 450. As previously described, electronic card 410 includes a magnetic stripe 414 reprogrammable depending on the card selected from the electronic card 410 and/or the electronic card holster 450. The electronic card holster 450 could further include a plate 484 on the back portion (e.g., and bottom portion) of the electronic card holster 450, which could include information about the electronic card 410 and/or electronic card holster 450 (e.g., manufacturer, owner, etc.).

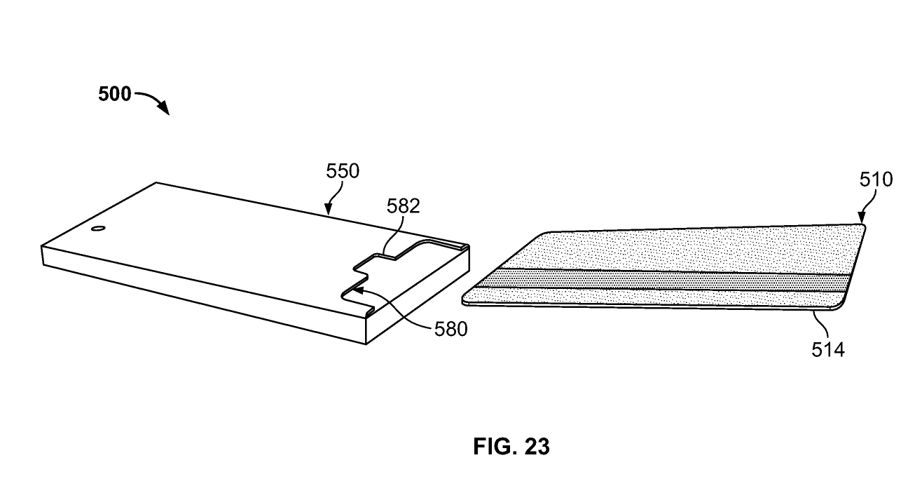

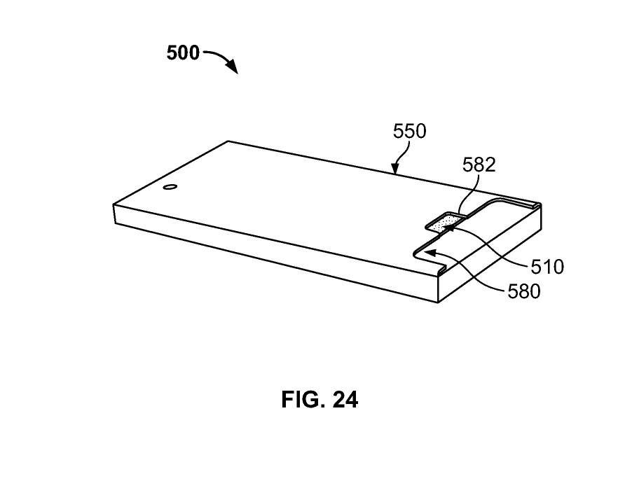

FIGS. 23-24 are views of a programmable electronic card assembly 500 comprising a programmable electronic card 510 and a smart phone 550. More specifically, FIG. 23 is a bottom perspective view of a programmable electronic card assembly 500 showing the programmable electronic card 510 and a smart phone 550. The electronic card 510 can be configured like, and operate like, the electronic card of FIGS. 1-22. The smart phone 550 interacts with the electronic card 510 similarly to the electronic card holster of FIGS. 19-22 and could function in a similar manner. The smart phone 550 (and/or each of its components) could have some or all of the same functionality as the electronic card 510 (and/or each of its components), or it could share such functional aspects with the electronic card 510 (as discussed above with the card holster).

The smart phone 550 includes a receptacle 582 in the body of the smart phone 550 (e.g., a slot 580 in the back of the smart phone 550) for receiving the programmable electronic card 510 to provide for communications (e.g., a first power interface) between the phone 550 and the card 510 and to charge the card 510 (e.g., inductive charging). The smart phone 550 includes, or could include, a display, an operating system (e.g., Android, iOS), software to control the programmable electronic card (e.g., an app), a keyboard (real or virtual), Internet connectivity (e.g., Wi-Fi, 3G/4g (SIM based), etc.), microphone, speaker, camera, apps (e.g., specific to the card and/or not specific to the card), fingerprint scan, EMV reader, EMV writer, EMV charger, card control software (e.g., native, API, etc.), etc.

The smart phone 550 allows a user to choose among one or more registered cards (e.g., credit cards) and/or other accounts. The smart phone 550 communicates (e.g., via a second communication interface) with the electronic card 510 to activate a selected card or account on the electronic card 510. Then, when the electronic card 510 is removed from the smart phone 550, the electronic card 510 is set to the selected card or account and is ready for use. The electronic card 510 could be provided with or without a display screen (as described above). As previously described, electronic card 510 includes a magnetic stripe 514 reprogrammable depending on the card selected from the electronic card 510 and/or the smart phone 550.

The electronic card 510 could be physically/mechanically interconnected with the smart phone 550 (e.g., a first power interface and/or a second communications interface) by a connector in the slot 580 of the smart phone 550 for information transfer and/or charging (e.g., a male connector in slot 580 inserts into a female connector in electronic card 510). Alternatively, or additionally, the electronic card 510 could be in wireless communication with the smart phone 550 (e.g., a first power interface and/or a second communications interface) by wireless technology for information transfer (e.g., NFC technology, Bluetooth technology, etc.) and/or wireless charging (e.g., inductive charging).

FIG. 24 is a bottom perspective view of the electronic card assembly of FIG. 23 with the electronic card received within the smart phone 550 (e.g., within a receptacle 580 of the smart phone 550). As shown, the electronic card 510 is received within slot 580 that may be positioned at the rear, and toward the top of the smart phone 550, although the slot 580 could alternatively be positioned in a side or bottom of the smart phone 550. The slot 580 is similarly sized to the dimensions of the electronic card 510 so as to frictionally prevent the electronic card 510 from accidentally falling out of the slot 580. However, the slot 580 could be of any size or shape, and any retaining mechanism could be used (e.g., clips) to retain the card 510 attached to the smart phone 550 in addition to or instead of the slot 580. The back of the smart phone 550 could include a notch 582 proximate to slot 580, to facilitate user access to and removal of the electronic card 510 from the smart phone 550.

The smart phone 550 could include a mechanical switch to lock/unlock the card in the receptacle 580, and/or protective material inside the receptacle 580 (e.g., to protect the display and/or magnetic stripe of the programmable electronic card 510). The increased size of the electronic smart phone 550 compared to the electronic card 510 allows for a comparatively larger battery. As a result, the smart phone 550 could charge the electronic card 510 when holstered therein (e.g., induction charging), either when the smart phone 550 is connected or disconnected from a power source.

Having thus described the invention in detail, it is to be understood that the foregoing description is not intended to limit the spirit or scope thereof. What is desired to be protected is set forth in the following claims.

What is claimed is:

1. A programmable electronic card assembly comprising:
a smart phone having a receptacle accessible from an exterior thereof; and
a programmable electronic card having a magnetic stripe removably positionable within the receptacle of the smart phone;
a first power interface for charging the programmable electronic card; and
a second communications interface for reprogramming the programmable electronic card.

2. The electronic card assembly of claim 1, wherein the smart phone comprises a graphical user interface screen which provides a plurality of card accounts that can be selected for use, the magnetic stripe of the electronic card electronically reprogrammable to include information relating to the selected credit card for use of the card at a point of sale.

3. The electronic card assembly of claim 1, wherein the second communications interface comprises near field communication technology.

4. The electronic card assembly of claim 1, wherein the plurality of card accounts includes a credit card.

5. The electronic card assembly of claim 1, wherein the plurality of card accounts includes a plurality of different types of cards.

6. The electronic card assembly of claim 1, wherein the smart phone displays a graphical emulation of a physical card on the user interface screen corresponding to the selected card account.

7. The electronic card assembly of claim 1, wherein the smart phone inductively charges the electronic card when the electronic card is positioned within the receptacle.

8. The electronic card assembly of claim 1, wherein the card body is shaped and sized to conform to the ISO/IEC 7810 ID-1 standard.

9. The electronic card assembly of claim 1, wherein the card body includes a graphical user interface screen on a surface of the card body.

10. The electronic card assembly of claim 1, wherein the receptacle of the smart phone comprises a slot.

11. The electronic card assembly of claim 10, wherein a wall of the slot includes a notch to facilitate user access to and removal of the electronic card from the smart phone.

12. A method of providing a programmable electronic card assembly comprising:
providing a programmable electronic card positionable in a receptacle of a smart phone;
allowing a user to use the smart phone to select one of a plurality of card accounts for the electronic programmable card;
electronically programming a magnetic stripe of the electronic card to include information relating to the selected card account; and
allowing the electronic card to be removed from the receptacle of the smart phone for use of the electronic card at a point of sale.

13. The method of claim 12, wherein the second communications interface comprises near field communication technology.

14. The method of claim 12, wherein the plurality of card accounts includes a credit card.

15. The method of claim 12, wherein the plurality of card accounts includes a plurality of different types of cards.

16. The method of claim 12, further comprising displaying on the smart phone a graphical emulation of a physical card corresponding to the selected card account.

17. The method of claim 12, further comprising inductively charging the electronic card when the electronic card is positioned within the receptacle of the smart phone.

18. The method of claim 12, wherein a card body of the electronic card is shaped and sized to conform to the ISO/IEC 7810 ID-1 standard.

19. The method of claim 12, wherein the receptacle of the smart phone comprises a slot.

20. The method of claim 19, wherein a wall of the slot includes a notch to facilitate user access to and removal of the electronic card from the smart phone.
